(19) United States
(12) Patent Application Publication
(10) Pub. No.: US 2014/0151042 A1
(43) Pub. Date: Jun. 5, 2014

(54) Chelate Compositions And Methods And Fluids For Use In Oilfield Operations

(71) Applicants: Lee Faugerstrom, Lagrangeville, NY (US); Robert L. Horton, Sugar Land, TX (US); Mark Luyster, Houston, TX (US); Chris Shepherd, Katy, TX (US); Bethicia B. Prasek, The Woodlands, TX (US); James Lepage, Lagrangeville, NY (US)

(72) Inventors: Lee Faugerstrom, Lagrangeville, NY (US); Robert L. Horton, Sugar Land, TX (US); Mark Luyster, Houston, TX (US); Chris Shepherd, Katy, TX (US); Bethicia B. Prasek, The Woodlands, TX (US); James Lepage, Lagrangeville, NY (US)

(73) Assignee: M-I L.L.C., Houston, TX (US)

(21) Appl. No.: 14/001,051

(22) PCT Filed: Feb. 22, 2012
(86) PCT No.: PCT/US12/26057

§ 371 Date: Feb. 17, 2014

Related U.S. Application Data
(60) Provisional application No. 61/445,386, filed on Feb. 22, 2011.
(60) Provisional application No. 61/445,363, filed on Feb. 22, 2011.

(51) Int. Cl. C09K 8/582; E21B 43/26; C09K 8/42; E21B 37/06; C09K 8/62; C09K 8/52; E21B 33/138; E21B 43/04

(52) U.S. Cl. CPC C09K 8/582; E21B 33/138; E21B 43/26; E21B 43/04; E21B 37/06; C09K 8/62; C09K 8/52; C09K 8/42
USPC 166/278; 166/300; 166/292; 507/201; 507/244; 507/267; 507/249

(57) ABSTRACT

A breaker fluid may include a base fluid; and an inactive chelating agent. A process may include pumping a first wellbore fluid comprising an inactive chelating agent into a wellbore through a subterranean formation; and activating the inactive chelating agent to release an active chelating agent into the wellbore.

### BACKGROUND OF INVENTION

1. Field of the Invention

Embodiments disclosed herein relate generally to chelate compositions, methods to activate chelating breakers, chemical breaker methods and breaker fluids for use in degrading, dissolving, dispersing and any combination thereof filter cakes formed in wellbores from drilling fluids, completion fluids, and/or fluid loss control pills, residual materials in production wells and/or or production equipment, or crosslinked polymer systems of fluid loss pills and/or fracturing fluids.

2. Background Art

Hydrocarbons (oil, natural gas, etc.) are typically obtained from a subterranean geologic formation (i.e., a “reservoir”) by drilling a well that penetrates the hydrocarbon-bearing formation. In order for hydrocarbons to be “produced,” that is, travel from the formation to the wellbore (and ultimately to the surface), there must be a sufficiently unimpeded flow path from the formation into the wellbore. One key parameter that influences the rate of production is the permeability of the formation along the flow path by which the hydrocarbon travels to reach the wellbore. Sometimes, the formation rock has a naturally low permeability; other times, the permeability is reduced, for example, during drilling of the wellbore.

During the drilling of a wellbore, various fluids are typically used in the well for a variety of functions. The fluids may be circulated through a drill pipe and drill bit into the wellbore, and may subsequently flow upward through the wellbore to the surface. During this circulation, the drilling fluid may act, for example, to remove drill cuttings from the bottom of the hole to the surface, to suspend cuttings and weighting material when circulation is interrupted, to control subsurface pressures, to maintain the integrity of the wellbore until the well section is cased and cemented, to isolate the fluids from the formation by providing sufficient hydrostatic pressure to prevent the ingress of formation fluids into the wellbore, to cool and lubricate the drill string and bit, and/or to maximize penetration rate.

One way of protecting the formation is by forming or depositing a filter cake on the surface of the subterranean formation. Filter cakes are formed when the fluid is defluidized, dehydrated, or depleted upon contact with a porous subterranean formation, thus particles suspended in a wellbore fluid plug the pores such that the filter cake prevents or reduces both the loss of fluids into the formation and the influx of fluids present in the formation when positive pressure is maintained from the wellbore to the subterranean formation. A number of ways of forming filter cakes are known in the art, including the use of bridging particles, cuttings created by the drilling process, polymeric additives, and precipitates.

Upon completion of drilling, the filter cake may stabilize the wellbore during subsequent completion operations such as placement of a gravel pack in the wellbore. Additionally, during completion operations, when fluid loss is suspected or anticipated, a fluid loss pill of polymers may be spotted to reduce or prevent such fluid loss through its viscosity by injection of other completion fluids behind the fluid loss pill to a position within the wellbore which is immediately above a portion of the formation where fluid loss is suspected. Injection of fluids into the wellbore is then stopped, and fluid loss will then move the pill toward the fluid loss location.

After completion operations have been accomplished, removal of the residual filter cake (formed during drilling and/or completion) may be necessary. Although filter cake formation and use of fluid loss pills are essential to drilling and completion operations, the barriers can be a significant impediment to the production of hydrocarbon or other fluids from the well as well as pose a potential to plug a sand control screen when utilized if, for example, the subterranean formation is still plugged by the barrier. Because the filter cake is defluidized and depleted, it often adheres strongly to the formation and may not be readily or completely removed by hydraulics alone.

The problems of efficient well clean-up, stimulation, and remediation are a significant issue in all wells, and especially in open-hole horizontal well completions. The productivity and contribution of the entire horizontal open hole is dependent on effectively and efficiently removing the residual filter cake while minimizing the potential of water blocking, plugging, or otherwise damaging the natural flow channels of the formation, as well as those of the lower completion installation, especially the selected sand control screen.

Accordingly, there exists a continuing need for chelate compositions that assist in removing the filter cake and chemical breaker methods and fluids that effectively clean the wellbore and do not inhibit the ability of the formation to produce hydrocarbons once the well is brought into production as well as the ability to inject fluids into a subterranean formation once a well is placed on injection. Wells desired for direct injection are even more sensitive to the aforementioned concerns and issues as related to removal of a residual filter cake.

### SUMMARY OF INVENTION

In one aspect, embodiments disclosed herein relate to a breaker fluid that includes a base fluid and an inactive chelating agent.

In another aspect, embodiments disclosed herein relate to a process that includes pumping a first wellbore fluid comprising an inactive chelating agent into a wellbore through a subterranean formation; and activating the inactive chelating agent to release an active chelating agent into the wellbore.

In yet another aspect, embodiments disclosed herein relate to a process that includes pumping a first wellbore fluid comprising a polysaccharide polymer, a bridging agent, and an inactive chelating agent into a wellbore through a subterranean formation; allowing some filtration of the first wellbore fluid into the subterranean formation to produce a filter cake comprising the polysaccharide polymer, bridging agent, and inactive chelating agent; and activating the inactive chelating agent to release an active chelating agent wherein the released active chelating agent reacts with the bridging agent in the wellbore.

Other aspects and advantages of the invention will be apparent from the following description and the appended claims.

### DETAILED DESCRIPTION

In one aspect, embodiments disclosed herein relate generally to chelate compositions that assist in removing filter cake and chemical breaker methods and fluids for use in degrading, dissolving, and/or dispersing filter cakes formed on wellbore walls either through drilling, or completion operations, residual materials accumulated during production or stimulation operations, or crosslinked fluids used during completion or fracturing operations. In particular, embodiments disclosed herein relate generally to wellbore fluids which include a base fluid, an inactive chelating agent that can be activated by an enzyme source, and an enzyme source capable of activating the inactive chelating agent. In some embodiments, the wellbore fluids include a base fluid and an inactive chelating agent, wherein the inactive chelating agent is activated by thermal hydrolysis. As used herein, an “inactive chelating agent” or an “enzyme-activated chelating agent” is a chelating agent that has been rendered substantially inactive (i.e., an inactive chelating agent is a weak or inactive chelating agent that does not react with filter cake components to cleave bonds) due to two or more ligands on the chelating agent that are bonded to other groups, rendering the ligands inactive or unavailable for complexing with cations or for sequestration of cations. In various embodiments, the chelating agent may have an amide (“amido-chelant”), an ester (“esterified-chelant”), a nitrile (‘nitrile-chelant“), and/or an anhydride (“anhydride-chelant”) linkage on two or more ligands of the inactive chelating agent. The amide, ester, nitrile, and anhydride linkages respectively present in the amido-chelant, esterified-chelant, nitrile-chelate and anhydride-chelant reduce the chelating strength of the inactive chelating agent by reducing the number of ligands available for complexation with cations. Thus, hydrolysis of the ester, amide, nitrile, and/or anhydride may increase the chelating strength by making carboxylate ligands available for complexation. Upon activation, such previously inactive chelating agents may be capable of selectively degrading fluid components remaining in the wellbore, such as filter cakes or other residual material that may form during drilling, completion, production or stimulation operations. Additional changes in the wellbore fluid environment (pH, temperature, etc.) may serve to regulate activity of the chelating agents. By controlling the activity of chelating agents contained in the wellbore fluid, several problems associated with wellbore fluid formulations may be avoided, thus increasing well productivity.

As discussed above, filter cakes are formed on walls of a subterranean borehole (or, for example, along the interior or exterior of a sand control screen) to reduce the permeability of the walls into and out of the formation (or screen). Some filter cakes are formed from wellbore fluids used during drilling or completion operations to limit losses from the wellbore and to protect the formation from possible damage by fluids and solids within the wellbore, while others are formed from spotted fluid loss pills to similarly reduce or prevent the influx and efflux of fluids across the formation walls. Filter cakes may be formed by adding various components to a wellbore fluid, pumping the fluid into the wellbore, and allowing the fluid to contact the desired subterranean formation. One skilled in the art would appreciate that a filter cake may comprise components such as drill solids, bridging/weighting agents, surfactants, fluid loss control agents, and viscosifying agents as residues left by the drilling fluid or fluid loss pill. Examples of bridging/weighting agents are calcium carbonate, barite, hematite, and manganese oxide, among others.

Typically, filter cakes are formed from fluids that contain polymers such as polysaccharide polymers, which may be degradable by a breaker fluid, including but not limited to starch derivatives, cellulose derivatives, biopolymers, and mixtures thereof Specifically, such polymers may include hydroxypropyl starch, hydroxyethyl starch, carboxymethyl starch, carboxymethyl cellulose, hydroxyethyl cellulose, hydroxypropyl cellulose, methyl cellulose, dihydroxypropyl cellulose, guar, xanthan gum, gellan gum, welan gum, and schleroglucan gum, in addition to their derivatives thereof, crosslinked derivatives thereof, and combinations of the foregoing. One of ordinary skill in the art would appreciate that this list is not exhaustive and that other polymers and additives may be present in the filter cakes to be degraded by the wellbore fluids of the present disclosure.

Similarly, after a well has been put into production, residual material may gradually accumulate on equipment and wellbore wells. When a production well is stimulated (to increase hydrocarbon production) or otherwise worked over, it may be desirable to remove some of such residual materials from the wellbore, to minimize any effect it may have on subsequent production.

The inactivated chelating agents of the present disclosure may also be used to break crosslinked polymer systems used as fluid loss pills or fracturing fluids. Such crosslinked polymer systems are often crosslinked by a metal ion, and thus such systems may be broken by an activated chelating agent that will complex with and/or sequester the metal crosslinkant. Alternatively, an activated chelating agent may be used to interact with the polymer itself and break the polymer system. Use of chelating agents to break fracturing fluids is described in U.S. Pat. No. 6,767,868 (complexing the crosslinkant), U.S. Pat. No. 6,706,769 (complexing with the polymer), and U.S. Pat. No. 7,208,529 (complexing with the polymer), each of which are herein incorporated by reference in their entirety.

The chemical breaker systems of the present disclosure are multi-component systems, and may include at least a base fluid, an inactive, enzyme-activated chelating agent, and an enzyme source, such that the enzyme source triggers activation of the enzyme-activated chelating agent. As mentioned above, the “inactive chelating agent or “enzyme-activated chelating agent” has been rendered substantially inactive (i.e., does not react with filter cake components or residual material to cleave bonds) due to the presence of an amide (“amido-chelant”), an ester (“esterified-chelant”) and/or a nitrile (“nitrile-chelant”) linkage on two or more ligands or an anhydride (“anhydride-chelant”) linkage on two or more ligands or between two ligands of the inactive chelating agent. The inactive chelating agent may then be substantially activated (i.e., strengthened to be placed in a reactive state) by thermal hydrolysis or by an enzyme source which hydrolyzes the amide, ester, nitrile, and/or anhydride linkage on the ligands of the inactive chelating agent to form a strong or activated chelating agent capable of breaking or degrading a filter cake, removing residual materials, or breaking crosslinked polymer systems. Activation of an inactive chelating agent in a breaker fluid may dissolve and chelate polyvalent metals or alkaline earth metals present in the filter cake, such as calcium in calcium carbonate, to aid in dissolution/degradation of the filter cake, polyvalent metal ions present as metal scale in residual materials in a production well or on production equipment, or crosslinked polymer systems in fluid loss pills and/or fracturing fluids.

In some embodiments of the invention, the chemical breaker systems include multi-component systems, and may include at least a base fluid and an inactive chelating agent, wherein the inactive chelating agent is activated by thermal hydrolysis instead of or in addition to activation with an enzyme. For non-limiting example, the inactive chelating agents of the present invention are activated by thermal hydrolysis by downhole temperatures or by application of heat at the surface or by providing an an external heat source to the wellbore fluid to heat the fluid downhole by any type of thermal energy, including microwave or radiowave. Thermal hydrolysis of inactive chelating agents may particularly be used for amide-chelants, nitrile-chelants, and anhydride chelants in certain embodiments of the present disclosure.

Activated chelating agents useful as breaking agents in the embodiments disclosed herein may include those which, upon activation by the enzyme source or thermal hydrolysis, sequester polyvalent cations through bonds to two or more hydrolyzed amide, ester, nitrile, and/or anhydride bonds on ligands of the chelating agent. Cations sequestered by the activated chelating agents may be sourced from solid filter cake components including various weighting or bridging agents such as without limitation calcium carbonate, barium sulfate, and other similar compounds, other metal salts forming residual material in production wells, and a variety of metals used to crosslink polymers used in fluid loss pills and/or fracturing fluids. Useful activated chelating agents may include organic ligands such as ethylenediamine, diaminopropane, diaminobutane, diethylenetriamine, triethylenetetraamine, tetraethylenepentamine, pentaethylenehexamine, tris(aminoethyl)amine, triaminopropane, diaminoaminoethylpropane, diaminomethylpropane, diaminodimethylbutane, bipyridine, dipyridylamine, phenanthroline, aminoethylpyridine, terpyridine, biguanide, pyridine aldazine, and combinations thereof.

In some embodiments, the strong or activated chelating agent may be a polydentate chelator such that multiple bonds are formed with the complexed metal ion. Polydentate chelators suitable may include, for example, ethylenediaminetetraacetic acid (EDTA), diethylenetriaminepentaacetic acid (DTPA), nitrilotriacetic acid (NTA), glutamic-N,N-diacetic acid (GLDA), methylglycine N,N-diacetic acid (MGDA), ethylene glycol-bis(2-aminoethyl)-N,N,N′,N′-tetraacetic acid (EGTA), 1,2-bis(o-aminophenoxy)ethane-N,N,N′,N′-tetraaceticacid (BAPTA), cyclohexanediaminetetraacetic acid (CDTA), triethylenetetraaminehexaacetic acid (TTHA), N-(2-Hydroxyethyl)ethylenediamine-N,N′,N′-triacetic acid (HEDTA), ethylene-diamine tetra-methylene sulfonic acid (EDTMS), diethylene-triamine penta-methylene sulfonic acid (DETPMS), amino tri-methylene sulfonic acid (ATMS), ethylene-diamine tetra-methylene phosphonic acid (EDTMP), diethylene-triamine penta-methylene phosphonic acid (DETPMP), amino tri-methylene phosphonic acid (ATMP), salts thereof, and mixtures of the foregoing. This list is not intended to have any limitation on the strong or activated chelating agents suitable for use in the embodiments disclosed herein. Rather, any compound having two or more ligands which terminate in at least one of a carboxylic acid, a sulfonic acid, and a phosphonic acid, which may be inactivated by an amide, ester, nitrile, and/or anhydride linkage may be used. The amide, ester, nitrile, and/or anhydride linkage may then be hydrolyzed to form a strong or activated chelating agent as described herein. One of ordinary skill in the art would recognize that selection of the strong or activated chelating agent may depend on the metals present down-hole in the filter cake, residual material, fluid loss pills, and/or fracturing fluids. In particular, the selection may be related to the specificity of the strong or activated chelating agent to the particular cations, the log K value, the optimum pH for sequestering and the commercial availability of the strong or activated chelating agent, as well as down-hole conditions, etc.

In a particular embodiment, the activated chelating agent may include glutamic acid N,N-diacetic acid (GLDA) and/or methylglycine N,N-diacetic acid (MGDA), and salts of the foregoing. In another embodiment, the activated chelating agent is NTA, a salt of NTA or a combination thereof, and is used to dissolve metal ions. NTA is an amino acid, as shown below, with three carboxylate groups and an amine group, which may sequester a metal ion (as shown below) such as Ca²⁺, Cu²⁺, and Fe³⁺.

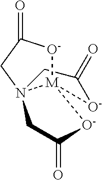

To dissolve/sequester some metals (e.g., barium), other strong or active chelating agents may be selected. For example, of several ^{ex}amp^{le} chelati^{ng} agents, the chelating power is, from strongest to weakest, DTPA, EDTA HEDTA, and GLDA.

Inactive chelating agents useful as delayed breaking agents in the embodiments disclosed herein may include amido-chelants and esterified-chelants such as polyethyl esters or amides, internal cyclic esters or amides, nitrile-chelants, anhydride-chelants and combinations thereof, which may be hydrolyzed to release a strong or activated chelating agent by elevated temperature or enzymes. Additionally, activated chelating agents such as those described heretofore may be inactivated and used in embodiments of the present disclosure. Inactivation of a chelating agent may be reversed upon exposure to a chemical or physical signal such as by altering the surrounding environment. According to preferred embodiments of the present disclosure, the inactive chelating agent may be activated by introduction of a triggering agent, for example, by injecting a hydrolyzing agent such as an enzyme into the wellbore fluid environment, and/or by thermally hydrolyzing the inactive chelating agent. One of ordinary skill in the art should appreciate that other agents or additives may be introduced to the wellbore fluid environment to trigger the release of an activated chelating agent, and/or rely on the temperature of the wellbore to hydrolyze the amides, esters, nitriles, and anhydrides to an activated chelate.

In a preferred embodiment, activation and release of a chelating agent is accomplished, at least in part, by introducing an agent into the wellbore fluid environment which is capable of hydrolyzing either a hydrolysable ester, hydrolysable amide, or hydrolysable nitrile, or hydrolysable anhydride bond contained in the inactive chelating agent to produce and/or release a strong or activated chelating agent which may then break or degrade fluid components remaining in the wellbore filter cakes. Hydrolysable esters, hydrolysable amides, and hydrolysable nitriles (or other similar compounds) include compounds which will release acid over a length of time. In one embodiment, a wellbore fluid may initially contain a base fluid and an inactive chelating agent, which may be later strengthened or activated by hydrolyzing ester, amide, nitrile, and/or anhydride linkages with an enzyme source and/or with thermal hydrolysis to release a strong or active chelating agent.

Compounds that may be hydrolyzed to form strong or activated chelating agents may be used as a delayed breaker capable of breaking or degrading the filter cake. In a preferred embodiment of the present disclosure, a wellbore fluid may contain a base fluid, an inactive chelating agent having a hydrolysable ester, and an ester hydrolysis enzyme source capable of hydrolyzing the hydrolysable ester to release an activated chelating agent into the wellbore, which may be used to break or degrade a carbonate-based filter cake. In another embodiment, a wellbore fluid may contain a base fluid, an inactive chelating agent having a hydrolysable amide such as an NTA amide and/or a glutamic-N,N-diamide, and an amide hydrolysis enzyme capable of hydrolyzing the hydrolysable amide to produce and/or release an active chelating agent and/or an acid into the wellbore, which may be used to break or degrade a carbonate-based filter cake. In another embodiment, a wellbore fluid may contain a base fluid, an inactive chelating agent having a hydrolysable nitrile such as a ethylenediaminetetraacetonitrile, nitrilotriacetonitrile and/or a glutamic-N,N-diacetonitrile and a nitrilase hydrolysis enzyme capable of hydrolyzing the hydrolysable nitrile to produce and/or release an active chelating agent and/or an acid into the wellbore, which may be used to break or degrade a carbonate-based filter cake.

Suitable ester-containing inactive chelating agents may include DISSOLVINE® HA CYCLIC, polyethyl esters, internal cyclic esters, and combinations thereof, which are more difficult to hydrolyze and thus, may offer a delayed chelating breaker. Hydrolysis of these ester-containing inactive chelating agents may offer a more slowly releasable chelating agent without added acidity due to hydrolysis yielding an ammonium salt of the chelating agent. Suitable amide-containing inactive chelating agents may include an NTA-amide, such as DISSOLVINE® A INHIBIT, and a glutamic-N,N-diamide, such as DISSOLVINE® GL AMIDE. Hydrolysis of these amide-containing inactive chelating agents may release nitrilo-triacetic acid and glutamic-N,N-diacetic acid, respectively, both of which are chelating agents active toward the calcium contained in carbonate filtercake bridging agents. In a preferred embodiment, hydrolysis of both the ester- and amide-containing inactive chelating agents may be accomplished using either an ester- or an amide-hydrolysis enzyme, respectively, or by thermal hydrolysis. Suitable nitrile-containing inactive chelating agents may include ethylenediaminetetraacetonitrile, nitrilotriacetonitrile and/or a glutamic-N,N-diacetonitrile.

Reaction of a chelating agent containing carboxylic acid or carboxylate groups with an alcohol may yield an ester; and reaction with an amine may yield an amide; and reaction with a carboxylic acid or carboxylate may yield an anhydride. Dehydration of an amide may in turn yield a nitrile; however, nitriles may be formed by other means as known in the art. Similarly, hydrolysis of the ester, amide, and nitrile, and anhydride may produce alcohol, amines, ammonia, and carboxylic acids, respectively. Thus, the alcohol, carboxylic acid or amine may be chosen in such a way that functional compounds may be incorporated into the wellbore fluid for a particular purpose. An alcohol reacted with a chelating agent to form an esterified-chelant may contain one or more further groups such as aromatic groups, amine groups, ether groups, ester groups, phosphorus-containing groups, sulfur-containing groups, amide groups, and hydroxyl groups. Preferably, the alcohol may be an aliphatic alcohol containing 1 to 12 carbon atoms that optionally may contain additional hydroxyl, amine and/or ether groups. In yet another embodiment, the alcohol may contain a primary or secondary hydroxyl group. In an even more specific embodiment, the alcohol may be chosen from the group of lower alcohols such as methanol, ethanol, propanol, butanol, pentanol, hexanol, heptanol, octanol, nonanol, decanol that may be linear or branched; glycols such as ethylene glycol, propylene glycol, diethylene glycol, dipropylene glycol, ethylene glycol mono butyl ether (EGMBE), neopentyl glycol, polyethylene glycol, polypropylene glycol, polyethylene glycol and polypropylene glycol based copolymers, and the like, and glycol ethers such as 2-methoxyethanol, diethylene glycol monomethyl ether; glycerol, hydroxypropanol, pentaerythritol, 1,1,1-trimethylol propane, 1,1,1-trimethylol ethane, 1,2,3-trimethylol propane, di-trimethylolpropane, di-pentaerythritol, 2-butyl-2-ethyl-1,3-propane diol, 1,6-hexane diol, cyclohexane dimethanol; lower amino alcohols such as aminoethanol, aminopropanol, aminobutanol; alkoxylated alcohols, preferably ethoxylated alcohols. Additionally, mixed esters are also covered within the scope of the present invention, i.e. esters of MGDA and/or GLDA (or other chelating agents) with two or more different alcohols. The lower alcohols and glycols may be preferred as they may have the advantage after hydrolysis of being mutual solvents, i.e. they are soluble in many oil- and water-based compounds and increase the compatibility between hydrophobic and hydrophilic materials. Alkoxylated alcohols may be desirable in that they can function as surfactants.

An amine reacted with the chelating agent to form an amide-chelant may contain one or more further groups like aromatic groups, amine groups, ether groups, ester groups, amide groups, phosphorus-containing groups, sulfur-containing groups, and hydroxyl groups. Preferably, the amine may be an aliphatic amine containing 1 to 12 carbon atoms that optionally may contain additional hydroxyl, carboxylic acid, amine and/or ether groups. In yet another embodiment, the amine contains a primary or secondary amino group. In an even more specific embodiment, the amine may be chosen from the group of lower amines such as aminomethane, aminoethane, aminopropane, aminobutane, aminopentane, aminohexane, aminoheptane, aminooctane, aminononane, aminodecane that may be linear or branched; lower amino alcohols such as aminoethanol, aminopropanol, aminobutanol; alkoxylated amines, preferably ethoxylated amines; amino acids that are well known to the person skilled in the art, such as the natural amino acids. Further, mixed amides are also within the scope of the present invention, i.e. amides of MGDA and/or GLDA (or other chelants) with two or more different amines. Alkoxylated amines may be desirable in that they can function as surfactants. Additionally, amines are known to often have an anticorrosive action and may be desirable for this reason.

In the embodiments wherein the chelating agent precursor of the present disclosure contains one or more anhydride groups, these anhydride groups are derived from the reaction of the chelating agent with a carboxylic acid. In a particular embodiment, this carboxylic acid may contain one or more further groups like aromatic groups, amine groups, ether groups, ester groups, amide groups, phosphorus-containing groups, sulfur-containing groups, and hydroxyl groups. Preferably, the carboxylic acid may be a fatty acid, or an aliphatic carboxylic acid containing 1 to 12 carbon atoms that optionally may contain additional hydroxyl, amine, carboxylic acid and/or ether groups. In a more specific embodiment, the carboxylic acid may be chosen from the group of lower carboxylic acids such as formic acid, acetic acid, propanoic acid, butanoic acid, pentanoic acid, hexanoic acid, heptanoic acid, octanoic acid, nonanoic acid, decanoic acid that may be linear or branched, glycolic acid; from the group of fatty acids that are well known to the person skilled in the art, such as lauric acid, myristic acid, palmitic acid, stearic acid, arachidic acid, oleic acid, oleinic acid, linoleic acid, α-linoleic acid, γ-linoleic acid, myristoleic acid, arachidonic acid, sapienic acid, erucic acid, palmitoleic acid, gadoleic acid, cetoleic acid, undecylenic acid, punicic acid, or a fatty acid derived from rapeseed oil, castor oil, safflower oil, linseed oil, soybeen oil, sesame oil, poppyseed oil, perilla oil, hempseed oil, grapeseed oil, sunflower oil, maize oil, tall oil, whale oil, hevea oil, tung oil, walnut oil, peanut oil, canola oil, cottonseed oil, sugarcane fatty acid. Mixed anhydrides are also within the scope of the present invention, i.e. anhydrides of MGDA and/or GLDA (or other chelating agents) with two or more different carboxylic acids. Additionally, it is also within the scope of the present disclosure that two or more ligands on a chelating agent may react with one another to form an internal anhydride. The carboxylic acids may be desirable as they may provide the solution with additional acidity after hydrolysis of the anhydride.

Further, it is also within the scope of the present disclosure that the inactivated chelating agents may contain two or more types of inactivating linkages, i.e. containing not only ester, amide, nitrile, or anhydride groups but containing a mixture of two or more of them. For ease of manufacturing, however, inactivated chelating agent in which the carboxylic acid/carboxylate groups are converted to the same ester, anhydride, nitrile, or amide group may be preferred.

Selection among the ester, amide, and/or nitrile, and anhydride may be based, for example, on the desired chemistry to be released from hydrolyzing the inactivated chelating agent, as well as the hydrolysis profile for the particular inactivated chelating agent. For example, esters, amides, and nitriles, and anhydrides all have different hydrolysis profiles, making it possible for a tailored molecule for a particular application to be made. Generally, anhydrides are often easier to hydrolyze than esters and amides are often more difficult to hydrolyze than esters, though of course the exact hydrolysis profile depends on the specific choice of the alcohol, amine and/or amine carboxylic acid with which the chelating agent is reacted, as well as the particular chelating agent. Therefore, depending on how much delay in releasing the acidity and chelating capacity is desired, the best choice in molecule design may be made.

Activation of an Inactivated Chelating Agent

As described above, upon activation of an inactive chelating agent, the chelating agent may function as a breaker and be used to break or degrade a filter cake. Activation of the inactive chelating agent may be accomplished under the temperature conditions of the wellbore (or application of heat from an external source) or using an enzyme to hydrolyze the amide, ester, nitrile, and/or anhydride bond to produce and/or release an active chelating agent, which may function to break or degrade a filter cake.

A wide variety of enzymes have been identified and separately classified according to their characteristics. A detailed description and classification of known enzymes is provided in the reference entitled ENZYME NOMENCLATURE (1984): RECOMMENDATIONS OF THE NOMENCLATURE COMMITTEE OF THE INTERNATIONAL UNION OF BIOCHEMISTRY ON THE NOMENCLATURE AND CLASSIFICATION OF ENZYME-CATALYSED REACTIONS (Academic Press 1984) (“Enzyme Nomenclature (1984)”), the disclosure of which is fully incorporated by reference herein. According to Enzyme Nomenclature (1984), enzymes can be divided into six classes, namely (1) Oxidoreductases, (2) Transferases, (3) Hydrolases, (4) Lyases, (5) Isomerases, and (6) Ligases. Each class is further divided into subclasses by action, etc. Although each class may include one or more enzymes that will activate the inactive chelating agents present in the wellbore fluid, as discussed herein, the classes of enzymes which may be most useful in the methods and embodiments of the present disclosure are (3) Hydrolases and (4) Lyases.

Class (3) Hydrolases are enzymes which function to catalyze the hydrolytic cleavage of various bonds including the bonds C—O, C—N, and C—C; however, of particular importance may be the C—O, C—N, and triple C—N (nitrile) bonds. Examples of enzymes within class (3) which may be used in embodiments of the present disclosure may include enzymes which act on ester bonds (esterases), such as phosphoric monoester hydrolases, and enzymes which act on peptide (amide) bonds and C—N bonds (peptide hydrolases), such as cysteine proteinases, for example, papain, fecin, bromelin, and actinidin, and enzymes which act on triple C—N (nitrile) bonds, for example nitrilases. Class (4) Lyases are enzymes which cleave C—C, C—O, C—N, and other bonds by means other than hydrolysis or oxidation. Examples of enzymes within class (4) which may be used in embodiments of the present disclosure may include carbon-oxygen lyases and carbon-nitrogen lyases. Such enzymes may be present in an amount ranging from 1 to 10 weight percent of the fluid.

Some embodiments of the present disclosure may use enzymes that have been encapsulated to render them inactive, but also pH-activatable. Thus, in a particular embodiment, the method by which the enzyme is activated involves release from the encapsulating material upon a change in pH in the down hole environment. However, in some embodiments, there may be a co-contributor to triggering activation of the enzyme, such as temperature, pressure, abrasion, etc. One skilled in the art would appreciate that such factors may be avoidably present downhole, and thus contribute to some extent, to the activation of the oxidant, but that the primary activation means, in accordance with the present disclosure is by pH activation. For the purposes of the present disclosure, an encapsulated enzyme is an enzyme that has a coating sufficient to control the release of enzyme until a set of conditions (e.g., sufficiently low pH) selected by the operator occurs. Some general encapsulating materials may include natural and synthetic oils, natural and synthetic polymers and enteric polymers and mixtures thereof. However, many methods of encapsulating may alternatively be used without departing from the scope of the present disclosure.

A suitable coating polymer may form a film around the enzyme, and may be chosen such that the coating will remain substantially intact until the desired release conditions occur, for example, a change in pH for the purposes of filter cake removal, scale removal, or breaking of fracturing fluid. In a particular embodiment, the encapsulating material includes enteric polymers, which are defined for the purposes of the present disclosure, as polymers whose solubility characteristics are pH dependent. Here, this means that enzyme release is promoted by a change from conditions of a first predetermined pH value to a second predetermined pH condition.

Enteric polymers are commonly used in the pharmaceutical industry for the controlled release of drugs and other pharmaceutical agents over time. The use of enteric polymers allows for the controlled release of the enzyme under predetermined conditions of pH or pH and temperature. For example the Glascol family of polymers are acrylic based polymers (available form Ciba Specialty Chemicals) are considered suitable enteric polymers for the present disclosure because the solubility depends upon the pH of the solution.

In an illustrative embodiment of the present disclosure, an enteric polymer may be selected as an encapsulating material that is substantially insoluble at pH values greater than about 7.5 and that is more soluble under conditions of decreasing pH. The pH of the fluid may be decreased in any manner known in the art, including by use of hydrolyzable esters of carboxylic acids or other delayed acid sources, such as those discussed in U.S. Patent Publication No. 2010/0270017, which is herein incorporated by reference in its entirety.

Illustrative examples of such delayed acid sources include hydrolyzable anhydrides of carboxylic acids, hydrolyzable esters of carboxylic acids; hydrolyzable esters of phosphonic acid, hydrolyzable esters of sulfonic acid and other similar hydrolyzable compounds that should be well known to those skilled in the art. Suitable esters may include carboxylic acid esters so that the time to achieve hydrolysis is predetermined on the known downhole conditions, such as temperature and pH. In a particular embodiment, the delayed pH component may include a formic or acetic acid ester of a C2-C30 alcohol, which may be mono- or polyhydric. Other esters that may find use in activating the oxidative breaker of the present disclosure include those releasing C1-C6 carboxylic acids, including hydroxycarboxylic acids formed by the hydrolysis of lactones, such as γ-lactone and δ-lactone). In another embodiment, a hydrolyzable ester of a C1 to C6 carboxylic acid and/or a C2 to C30 poly alcohol, including alkyl orthoesters, may be used. In a particular embodiment, the delayed acid source may be provided in an amount greater than about 1 percent v/v of the wellbore fluid, and ranging from about 1 to 50 percent v/v of the wellbore fluid in yet another aspect. However, one of ordinary skill in the art would appreciate that the preferred amount may vary, for example, on the rate of hydrolysis for the particular acid source used. In a particular embodiment, the enteric polymer encapsulated enzyme is combined with a wellbore fluid having a pH greater than 7.5 so as to avoid premature release of the enzyme.

Additional Wellbore Fluid Components

Other additives that may be included in some of the wellbore fluids disclosed herein include for example, weighting agents, wetting agents, viscosifiers, fluid loss control agents, surfactants, dispersants, interfacial tension reducers, pH buffers, mutual solvents, thinners, thinning agents and cleaning agents. The addition of such agents should be well known to one of ordinary skill in the art of formulating wellbore fluids, including drilling fluids, completion fluids, breaker fluids, workover fluids, and the like.

Methods and wellbore fluids of the present disclosure may optionally contain a mutual solvent, which may aid in reducing surface tension. For example, where increased penetration rate into the filter cake is desired, a mutual solvent may be included to decrease the viscosity of the fluid and increase penetration of the fluid components into the filter cake to cause breaking and/or degrading thereof. Conversely, where additional delay is desired, a lesser amount or zero mutual solvent may be included to increase viscosity and thus reduce penetration rate. One example of a suitable mutual solvent may be a butyl carbitol. The use of the term “mutual solvent” includes its ordinary meaning as recognized by those skilled in the art, as having solubility in both aqueous and oleaginous fluids. In some embodiments, the solvent may be substantially completely soluble in each phase while in select other embodiments, a lesser degree of solubilization may be acceptable. Further, in a particular embodiment, selection of a mutual solvent may depend on factors such as the type and amount of salt present in the fluid.

The various components of the present disclosure may be provided in wellbore fluids which may have an aqueous fluid as the base liquid. The aqueous fluid may include at least one of fresh water, sea water, brine, mixtures of water and water-soluble organic compounds and mixtures thereof For example, the aqueous fluid may be formulated with mixtures of desired salts in fresh water. Such salts may include, but are not limited to alkali metal chlorides, hydroxides, carboxylates, and combinations thereof, for example. In various embodiments of the wellbore fluid disclosed herein, the brine may include seawater, aqueous solutions wherein the salt concentration is less than that of sea water, or aqueous solutions wherein the salt concentration is greater than that of sea water. Salts that may be found in seawater include, but are not limited to, sodium, calcium, sulfur, aluminum, magnesium, potassium, strontium, and lithium, salts of chlorides, bromides, carbonates, iodides, chlorates, bromates, formates, nitrates, oxides, sulfates, silicates, phosphates, fluorides, and combinations of the foregoing. Salts that may be incorporated in a brine include any one or more of those present in natural seawater or any other organic or inorganic dissolved salts. Additionally, brines that may be used in the drilling fluids disclosed herein may be natural or synthetic, with synthetic brines tending to be much simpler in constitution. In one embodiment, the density of the drilling fluid may be controlled by increasing the salt concentration in the brine (up to saturation). In a particular embodiment, a brine may include halide or carboxylate salts of mono- or divalent cations of metals, such as cesium, potassium, calcium, zinc, and/or sodium, and combinations thereof.

Breaking the Filter Cake, Residual Materials and/or Fracturing Fluid

The multi-component breaker systems of the present disclosure may be used to treat a wellbore in a variety of methods. For example, the fluids and/or order in which the components are emplaced may vary depending on the particular wellbore to be treated. Specifically, the breaker may be an internal breaker, residing in the formed filter cake, or may be an external breaker and be emplaced downhole subsequent to the formation of the filter cake. In one embodiment, the inactivated chelating agent is activated by thermal hydrolysis. Thermal hydrolysis may be used when the inactivated chelating agent is either an internal breaker or an external breaker.

Other embodiments of the present disclosure may use an enzyme source in addition to or instead of thermal hydrolysis to activate the inactivated chelating agent. In one embodiment, a fluid containing at least one inactivated chelating agent is pumped into the wellbore and a filter cake is thus formed that incorporates the not-yet-activated chelating agent. At some period of time later, when it may be desirable to remove the filter cake, the enzyme-activated chelating agent may be activated by the introduction of an enzyme source capable of hydrolyzing amide, ester, nitrile, and/or anhydride linkages on two or more ligands of the inactive chelating agent. Again, it should be emphasized that this is merely one possible mechanism by which the chelating agent release may occur in the downhole environment. Those skilled in the art will recognize that other factors, or a combination of factors, such as thermal hydrolysis, may in fact aid in the activation of the chelating agent. The methods discussed here are intended to illustrate possible mechanisms by which activation may occur and are not intended to narrow the scope of the invention, as defined by the claims herein. At least a portion of the inactive chelating agent may be activated using an enzyme (e.g., a hydrolase or lyase enzyme, or others discussed above) to hydrolyze amide, ester, nitrile, and/or anhydride linkages contained on two or more ligands of the inactive chelating agent to produce and/or release at least one chelating agent. The at least one produced or released chelating agent may then further contribute to the degradation and removal of the filter cake deposited on the sidewalls of the wellbore (or gravel packing equipment).

Alternatively, the inactivated chelating agent may be in the wellbore subsequent to the formation of a filter cake when the breaker is activated. That is, subsequent to formation of the filter cake, an inactivated chelating agent and enzyme source may be pumped into the wellbore at some period of time later. The enzyme component may then activate the chelating agent by hydrolyzing amide, ester, nitrile, and/or anhydride linkages contained on two or more ligands of the inactive chelating agent. Further, depending on the choice of the engineer, the inactivated chelating agent and enzyme source may be pumped into the wellbore simultaneously in the same fluid, or sequentially in different fluids (in either order). Further, in yet another alternative embodiment, the inactivated chelating agent and/or the enzyme source may be pumped together with the filter cake components that will eventually be broken.

In one illustrative embodiment, an inactivated chelating agent is pumped into a wellbore with polysaccharide polymers and bridging agents in a first wellbore fluid (e.g., in a drilling fluid). As some of the fluid permeates into the formation, a filter cake containing polysaccharide polymers, bridging agents, and the enzyme-activated chelating agent is formed. When it is desirable to break the formed filter cake, a second wellbore fluid containing an enzyme source is pumped downhole. Upon introduction of the enzyme source, amide, ester, nitrile, and/or anhydride linkages on the ligands of the inactive chelating agent may be hydrolyzed, triggering the activation of the previously inactive chelating agent. The activated chelating agent may then react with the bridging agents forming the filter cake to cause degradation of the filter cake. Polysaccharide polymers may be broken down by the enzymes present in the breaker fluids or by other breaking agents optimally included. If desirable, a wash fluid may then be subsequently circulated in the wellbore to remove the degraded filter cake material.

In another illustrative embodiment, a first wellbore fluid (e.g., in a drilling fluid) containing polysaccharide polymers and bridging agents is pumped into a wellbore. As some of the fluid permeates into the formation, a filter cake containing polysaccharide polymers and bridging agents is formed. When it is desirable to break the formed filter cake, a second wellbore fluid containing an inactivated chelating agent is pumped downhole, followed by a third wellbore fluid containing an enzyme source is pumped downhole. Upon pumping of the enzyme source, amide, ester, nitrile, and/or anhydride linkages on the ligands of the inactive chelating agent may be hydrolyzed, triggering the activation of the previously inactive chelating agent. The activated chelating agent may then react with the bridging agents forming the filter cake to cause degradation of the filter cake while polysaccharide polymers may be broken by enzymatic cleavage or other breaking agents included in the fluid. If desirable, a wash fluid may then be subsequently circulated in the wellbore to remove the degraded filter cake material. While this embodiment refers to the sequential pumping of the second and third wellbore fluids, one of ordinary skill in the art would appreciate that the order of pumping may be reversed, with the enzyme source followed by the inactivated chelating agent.

Advantageously, embodiments of the present disclosure may provide for the controllable removal and clean-up of a filter cake formed during drilling or completion operations by using a wellbore fluid that contains a delayed chelating agent. Additionally, because the activation is delayed, the timing of such filter cake breaking and/or degrading may be controlled.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed:

1. A breaker fluid comprising:
a base fluid; and
an inactive chelating agent.

2. The breaker fluid of claim 1, further comprising:
an enzyme source capable of activating the inactive chelating agent.

3. The breaker fluid of claim 1, further comprising:
at least one of a surfactant, an oxidant, a pH buffer, a mutual solvent, a cleaning agent, and combinations thereof

4. The breaker fluid of claim 2, wherein the enzyme source is added to the breaker fluid after both the base fluid and the inactive chelating agent have been introduced to a wellbore.

5. The breaker fluid of claim 1, wherein the inactive chelating agent comprises at least one of an amido-chelant, an esterified-chelant, a nitrile-chelant, and combinations thereof.

6. The breaker fluid of claim 5, wherein the amide, ester, nitrile, and anhydride linkage respectively present in the amido-chelant, esterified-chelant, and nitrile-chelant reduce the chelating strength of the inactive chelating agent.

7. The breaker fluid of claim 5, wherein the amido-chelant comprises at least one of a polyethyl amide, an internal cyclic amide, and combinations thereof.

8. The breaker fluid of claim 5, wherein the esterified-chelant comprises at least one of a polyethyl ester, an internal cyclic ester, and combinations thereof.

9. The breaker fluid of claim 5, wherein the nitrile-chelant comprises a nitrile group.

10. The breaker fluid of claim 2, wherein the enzyme source comprises at least one of an esterase, a phosphoric monoester hydrolase, a peptide hydrolase, a cysteine proteinase, a nitrilase, and combinations thereof.

11. The breaker fluid of claim 10, wherein the cysteine proteinase comprises at least one of papain, fecin, bromelin, actinidin, and combinations thereof.

12. The breaker fluid of claim 11, wherein the cysteine proteinase comprises papain.

13. A process comprising:
pumping a first wellbore fluid comprising an inactive chelating agent into a wellbore through a subterranean formation; and
activating the inactive chelating agent to release an active chelating agent into the wellbore.

14. The process of claim 13, further comprising:
pumping a second wellbore fluid comprising an enzyme source into the wellbore; and

15. The process of claim 14, wherein the first wellbore fluid and the second wellbore fluid are pumped simultaneously as a single fluid.

16. The process of claim 14, wherein the first wellbore fluid is pumped into the wellbore a predetermined amount of time before the second wellbore fluid is pumped into the wellbore.

17. The process of claim 13, wherein the inactive chelating agent comprises at least one of an amido-chelant, an esterified-chelant, a nitrile-chelant, and combinations thereof.

18. The process of claim 13, wherein the active chelating agent is capable of breaking or degrading a filter cake.

19. The process of claim 14, wherein the first wellbore further comprises at least one polysaccharide polymer and bridging agent.

20. The process of claim 19, further comprising:
allowing some filtration of the first wellbore fluid into the subterranean formation to produce a filter cake comprising the inactive chelating agent.

21. The process of claim 13, wherein the first wellbore fluid further comprises:
at least one of a weighting agent, a wetting agent, a viscosifier, a fluid loss control agent, a surfactant, a dispersant, an interfacial tension reducer, a pH buffer, a mutual solvent, a thinner, a thinning agent, a cleaning agent, and combinations thereof.

22. The process of claim 20, wherein the first wellbore fluid and the second wellbore fluid are pumped simultaneously as a single fluid into the wellbore.

23. The process of claim 20, wherein the first wellbore fluid is pumped into the wellbore a predetermined amount of time before the second wellbore fluid is pumped into the wellbore.

24. The process of claim 13, further comprising:
pumping a fluid loss pill comprising a crosslinked polymer, wherein the active chelating agent breaks at least a portion of the crosslinked polymer.

25. The process of claim 13, further comprising:
pumping a fracturing fluid comprising a crosslinked polymer, wherein the active chelating agent breaks at least a portion of the crosslinked polymer.

26. A process comprising:
pumping a first wellbore fluid comprising a polysaccharide polymer, a bridging agent, and an inactive chelating agent into a wellbore through a subterranean formation;
allowing some filtration of the first wellbore fluid into the subterranean formation to produce a filter cake comprising the polysaccharide polymer, bridging agent, and inactive chelating agent; and
activating the inactive chelating agent to release an active chelating agent wherein the released active chelating agent reacts with the bridging agent in the wellbore.

27. The process of claim 26, further comprising:
pumping a second wellbore fluid comprising an enzyme source into the wellbore.

28. The process of claim 27, wherein the enzyme source hydrolyzes at least a portion of the first wellbore fluid so as to activate the inactive chelating agent.

29. The process of claim 27, wherein the first wellbore fluid is pumped into the wellbore a predetermined amount of time before the second wellbore fluid is pumped into the wellbore.
